(19) United States
(12) Patent Application Publication
(10) Pub. No.: US 2024/0338194 A1
(43) Pub. Date: Oct. 10, 2024

(54) COMPUTER NETWORK AND METHOD OF AUTOMATIC UPDATING FIRMWARE TO PERIPHERAL DEVICE USING UNIFIED EXTENSIBLE FIRMWARE INTERFACE

(71) Applicant: Wiwynn Corporation, New Taipei City (TW)

(72) Inventors: Tsu-Hao Lai, New Taipei City (TW); Chih-Yuan Lin, New Taipei City (TW); Chih-Yuan Hung, New Taipei City (TW)

(73) Assignee: Wiwynn Corporation, New Taipei City (TW)

(21) Appl. No.: 18/227,990

(22) Filed: Jul. 31, 2023

(30) Foreign Application Priority Data
Apr. 7, 2023 (TW) 112112986

(51) Int. Cl. G06F 8/65; G06F 13/42

(52) U.S. Cl. CPC G06F 8/65; G06F 13/4221

(57) ABSTRACT

A method of updating firmware to a peripheral device of a computer system in a computer network. The computer system includes a host, a system on chip (SoC), and a basic input/output system (BIOS). The host is coupled to the SoC, the SoC is coupled to the BIOS, and the BIOS is coupled to a peripheral device. The method includes an operating system (OS) running on the host controlling the SoC to initiate a firmware update to the peripheral device, in response to the firmware update, the SoC enabling the BIOS to enter a unified extensible firmware interface (UEFI), the UEFI executing an update script to update a peripheral firmware to the peripheral device, and performing a reboot to the complete firmware update to the peripheral device.

### BACKGROUND OF THE INVENTION

### 1. Field of the Invention

The present invention relates to firmware update, and in particular, to a computer network and a method of automatic updating firmware to peripheral devices of a computer system in the computer network using a unified extensible firmware interface.

### 2. Description of the Prior Art

A server is a computer system for handling a large amount of data and traffic. Users may access resources such as applications, files, databases, and emails on the server via an intranet or the Internet. The functionality of the server may be expanded by connecting to external peripheral devices. For example, a file server may increase the storage capacity by connecting to an external hard drive via an input/output controller (IOC). The peripheral devices may need firmware update to increase or enhance the functionalities.

In the related art, a user needs to use an unified extensible firmware interface (UEFI) to manually update the firmware. Nevertheless, the firmware updating process is complex, degrading the user experience. First, the user needs to pay attention to the timing of manually switching to the basic input/output system (BIOS). For example, the user needs to hold down the “Delete” key for a predetermined period of time after a reboot in order to enter the BIOS menu. Secondly, after entering the BIOS menu, the user needs to manually enter the UEFI, yet finding the UEFI option is not intuitive. For an unfamiliar user, it might take some time to find the UEFI option from the BIOS menu. Finally, even if the firmware update process is known, an unexpected error might still occur and requires technical personnel to troubleshoot problems remotely, e.g., using a specific toolbox or a specific instruction to troubleshoot the user input error.

In other related art, the user may update the firmware from the operating system without going through the UEFI, known as “in-band update”. However, the in-band update is unavailable for updating to a different firmware version, since the instruction addresses of different versions of the firmware will change accordingly. In such a case, manually entering the UEFI to update the firmware is still necessary, at the cost of degrading the user experience.

### SUMMARY OF THE INVENTION

According to an embodiment of the invention, a computer system includes a host, a system on chip (SoC), and a basic input/output system (BIOS), the host being coupled to the SoC, the SoC being coupled to the BIOS, the BIOS being coupled to a peripheral device. A method for updating firmware of the peripheral device of the computer system in a computer network includes an operating system (OS) running on the host controlling the SoC to initiate a firmware update of the peripheral device, in response to the firmware update of the peripheral device, the SoC enabling the BIOS to enter a unified extensible firmware interface (UEFI), the UEFI executing an update script to update a peripheral firmware to the peripheral device, and performing a reboot to complete the firmware update of the peripheral device.

According to another embodiment of the invention, a computer network includes a computer system, the computer system including a host, a system on chip (SoC), and a basic input/output system (BIOS). The host includes an operating system (OS). The system on chip (SoC) is coupled to the host. The basic input/output system (BIOS) is coupled to the host, the SoC, and a peripheral device. The operating system is used to run on the host to control the SoC to initiate a firmware update of the peripheral device. In response to the firmware update of the peripheral device, the SoC is used to enable the BIOS to enter a unified extensible firmware interface (UEFI). The UFI is used to execute an update script to update a peripheral firmware to the peripheral device. The computer system is used to perform a reboot to complete the firmware update of the peripheral device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a computer system according to an embodiment of the invention.

FIG. 2 is a flowchart of a method of updating a firmware of the peripheral device of the computer system in FIG. 1.

FIG. 3 is a block diagram of a computer network including the computer system in FIG. 1.

FIG. 4 is a flowchart of a method of updating a firmware of the peripheral device of the computer network in FIG. 3.

### DETAILED DESCRIPTION

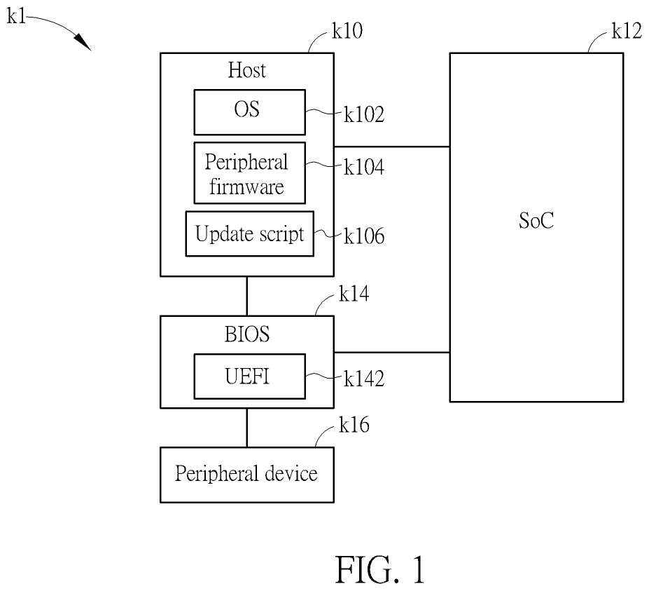

FIG. 1 is a block diagram of a computer system k1 according to an embodiment of the invention. The computer system k1 may be a network attached storage (NAS) server for data backup, file sharing, and data management. The computer system k1 may be connected to other computers or devices via a network, and may provide reliable data transmission and data storage. The computer system k1 may be coupled to a peripheral device k16 to expand functionalities. The peripheral device k16 may be a peripheral component interconnect express (PCI-E) device. For example, the peripheral device k16 may be an input/output controller (IOC) or other PCI-E devices. If peripheral device k16 is the IOC, the computer system k1 may be coupled to a PCI-E hard disk, a solid-state drive (SSD), and/or other storage devices supporting a unified extensible firmware interface (UEFI) via the peripheral device k16, so as to expand the storage space. The computer system k1 may support an automatic firmware update and restoration of the peripheral device k16 via the UEFI without additional hardware or complicated circuits, enhancing user experience, reducing maintenance cost, while reducing the requirements for firmware updates, providing fast and convenient peripheral maintenance to all users.

The computer system k1 may include a host k10, a system on chip (SoC) k12 and a basic input/output system (BIOS) k14. The SoC k12 is coupled to the host k10, and the BIOS k14 is coupled to the host k10, the SoC k12 and the peripheral device k16. While in FIG. 1, the computer system k1 is coupled to only one peripheral device k16, the computer system k1 may also be coupled to a plurality of peripheral devices k16.

The host k10 may store an operating system (OS) k102, a peripheral firmware k104 and an update script k106. In some embodiments, the peripheral firmware k104 may be stored in the peripheral device k16. In some embodiments, the OS k102 may be Microsoft Windows, linux, or macOS. The peripheral firmware k104 and the update script k106 may be pre-stored in the host k10 locally or remotely. The update script k106 may include a plurality of instructions, when being executed, the firmware of the peripheral device k16 may be updated or restored. The BIOS k14 may access the peripheral firmware k104 of the host k10 via the UEFI k142. However, the host k10 must enter and control the BIOS k14 and the UEFI k142 via the SoC k12. During a reboot, the UEFI k142 may load minimum drivers and firmware required to perform a reboot test on the computer system k1, so as to quickly ensure normal operations of the computer system k1 while achieving fast startup. The BIOS k14 provides standard hardware and firmware operations via the UEFI k142, supporting a fast reboot and large hard disk capacity. In this embodiment, the UEFI k142 may access the host k10 to load the update script k106 and the peripheral firmware k104, and execute the update script k106.

The SoC k12 may be a baseboard management controller (BMC) for monitoring and controlling components of the computer system k1 such as a power supply, a fan, a temperature sensor and a storage device. In addition, the SoC k12 may further provide a remote management function, allowing a system administrator to remotely monitor and control the computer system k1.

The computer system k1 may integrate the host k10, the SoC k12 and the BIOS k14, and executes the update script k106 to update or restore the firmware of the peripheral device k16.

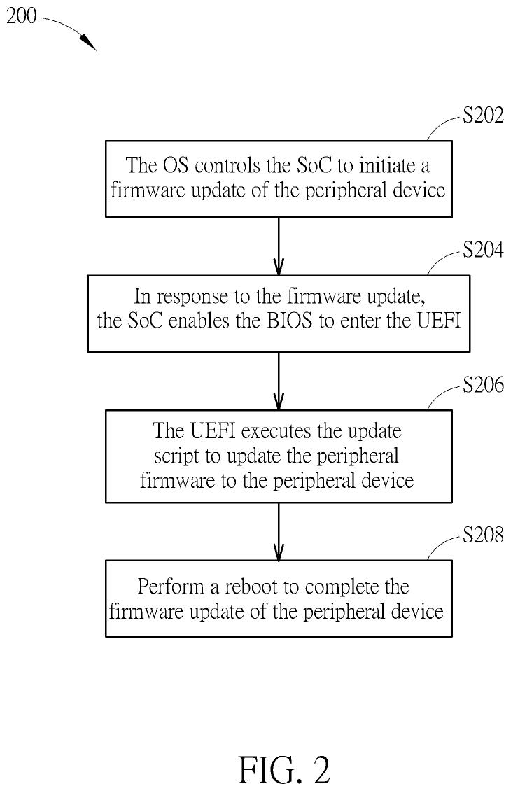

FIG. 2 is a flowchart of a method 200 of updating a firmware of the peripheral device k16 of the computer system k1. The method 200 includes Steps S202 to S208 for updating or restoring the firmware of the peripheral device k16. Any reasonable step change or adjustment is within the scope of the disclosure. Steps S202 to S208 are detailed as follows:
Step S202: The OS k102 running on the host k10 controls the SoC k12 to initiate a firmware update of the peripheral device k16;
Step S204: In response to the firmware update, the SoC k12 enables the BIOS k14 to enter the UEFI k142;
Step S206: The UEFI k142 executes the update script k106 to update the peripheral firmware k104 to the peripheral device k16;
Step S208: Perform a reboot to complete the firmware update of the peripheral device k16.

In Step S202, the firmware update of the peripheral device k16 is triggered upon the host k10 receives a firmware update instruction. Since the firmware update may only be performed after entering the BIOS k14 and the UEFI k142, a user may manually reboot the computer system k1. After rebooting, since the host computer k10 may not directly control the BIOS k14 and UEFI k142 but must use the SoC k12 to control the BIOS k14 and UEFI k142, the OS k102 sends a set of instructions to the SoC k12 to initialize the firmware update of the peripheral device k16. The set of instructions may include a first instruction for the SoC k12 to instruct the BIOS k14 to enter the UEFI k142 (Step S204). The set of instructions may further include a second instruction for the SoC k12 to instruct the peripheral device k16 to perform the firmware update. Since the computer system k1 may include one or a plurality of peripheral devices k16, the SoC k12 may instruct the peripheral device k16 to perform the firmware update on selected peripheral devices k16 according to the second instruction. In some embodiments, the computer system k1 may only include one peripheral device k16, and the SoC k12 may instruct the UEFI k142 to perform the firmware update on the peripheral device k16 according to the second instruction. In other embodiments, the computer system k1 may only include two peripheral devices k16, and the SoC k12 may instruct the UEFI k142 to perform the firmware update on the two peripheral devices k16 according to the second instruction. In other embodiments, the computer system k1 may only include two peripheral devices k16, and the SoC k12 may instruct the UEFI k142 to perform firmware update on one of the two peripheral devices k16 according to the second instruction. In other embodiments, the computer system k1 may include more than two peripheral devices k16, and the SoC k12 may instruct the UEFI k142 to perform the firmware update on all peripheral devices k16 or a portion of all peripheral devices k16 according to the second instruction. For example, the computer system k1 may only include two I/O controllers, and the SoC k12 may instruct the UEFI k142 to perform the firmware update on the two I/O controllers according to the second instruction.

In Step S206, the UEFI k142 may load the update script k106 from the host k10, and execute the update script k106 to update the firmware of the selected peripheral device k16. In some embodiments, when the update script k106 is executed, the UEFI k142 obtains the peripheral firmware k104 from the host k10, and programs the peripheral firmware k104 to predetermined addresses of the memory in the selected peripheral device k16. The memory of the selected peripheral device k16 may be a flash memory or other non-volatile memory. Then in Step S208, the computer system k1 may be rebooted to complete the firmware update of the selected peripheral device k16.

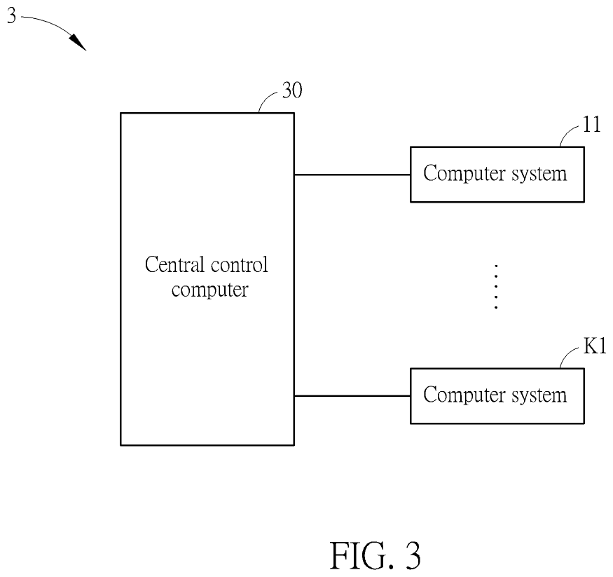

FIG. 3 is a block diagram of a computer network 3 including the computer system k1. The computer network 3 may include a central control computer 30 and computer systems 11 to K1, where K is a positive integer. For example, if K=2, then the computer network 3 includes computer systems 11 and 21. Each computer system K1 in FIG. 3 may be similar to the computer system k1 in FIG. 1 and may be coupled to a respective peripheral device k16, wherein k is a positive integer between 1 and K. The number of peripheral devices k16 of each computer system k1 may be equal or different. For example, the computer system 11 may include two peripheral devices 116, and the computer system 21 may include two peripheral devices 216. The central control computer 30 may remotely transmit firmware update instructions to the computer systems 11 and 21, so as to trigger the computer system 11 to update or restore the firmware of the two peripheral devices 116, and trigger the computer system 21 to update or restore the two peripheral devices 216.

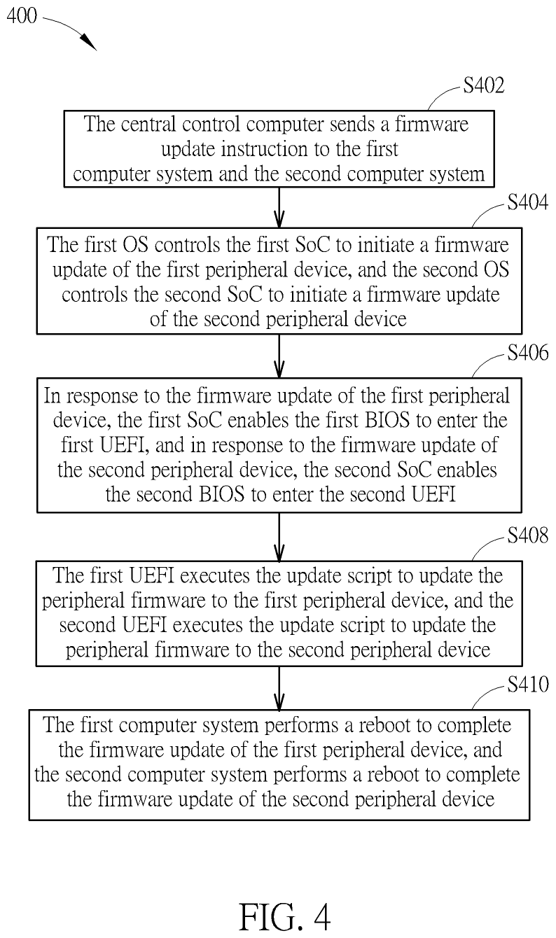

FIG. 4 is a flowchart of a method 400 of updating a firmware of the peripheral device of the computer network 3. The firmware update method 400 includes Steps S402 to S410 to trigger a plurality of computer systems in the computer network 3 to update or restore the firmware of the respective peripheral devices. Any reasonable step change or adjustment is within the scope of the disclosure. Steps S402 to S410 are detailed as follows:
Step S402: The central control computer sends a firmware update instruction to the first computer system and the second computer system;
Step S404: The first OS controls the first SoC to initiate a firmware update of the first peripheral device, and the second OS controls the second SoC to initiate a firmware update of the second peripheral device;
Step S406: In response to the firmware update of the first peripheral device, the first SoC enables the first BIOS to enter the first UEFI, and in response to the firmware update of the second peripheral device, the second SoC enables the second BIOS to enter the second UEFI;
Step S408: The first UEFI executes the update script to update the peripheral firmware to the first peripheral device, and the second UEFI executes the update script to update the peripheral firmware to the second peripheral device;
Step S410: The first computer system performs a reboot to complete the firmware update of the first peripheral device, and the second computer system performs a reboot to complete the firmware update of the second peripheral device.

The method 400 for updating firmware will be described below with reference to the computer network 3 including the computer systems 11 and 21, and the computer systems 11 and 21 are respectively coupled to two peripheral devices.

In Step S402, the central control computer 30 sends a firmware update instruction to the computer systems 11 and 21 to respectively trigger the computer systems 11 and 21 to start firmware updates of the respective peripheral devices. Other than that Steps S404 to S410 are performed by the computer systems 11 and 21, respectively, and Steps S202 to S208 are performed by a single computer system k1, Steps S404, S406 and S410 are similar to Steps S202, S204 and S208 respectively, and the explanation therefor will not be repeated here for brevity.

In Step S408, the OS 1102 of the computer system 11 sends a set of instructions to the SoC 112 to initiate the firmware update of the two peripheral devices 116, and the OS 2102 of the computer system 21 sends a set of instructions to the SoC 212 to initiate the firmware update of the two peripheral devices 216. The set of instructions sent by OS 1102 may include a first instruction for SoC 112 to instruct BIOS 114 to enter the UEFI 1142, and the set of instructions sent by OS 2102 may include a first instruction for SoC 212 to instruct BIOS 214 to enter the UEFI 2142. Further, the set of instructions sent by the OS 1102 may include a second instruction to enable the SoC 112 to instruct the peripheral device 116 to perform the firmware update, and the set of instructions sent by the OS 2102 may include a second instruction to enable the SoC 212 to instruct the peripheral device 216 to perform the firmware update. If the respective two peripheral devices of the computer systems 11 and 21 need to update the firmware, the SoC 112 may instruct the UEFI 1142 to perform the firmware update on the two peripheral devices 116 according to the second instruction, and the SoC 212 may instruct the UEFI 2142 to perform the firmware update on the two peripheral devices 216 according to the second instruction.

Although the method 400 is described with reference to two computer systems in the computer network 3, the present invention is not limited thereto, those skilled in the art may apply the method 400 to update other computer systems based on the principle of the invention.

The embodiments in FIGS. 1 to 4 use the UEFI to support automatic firmware update and restoration of peripheral devices without additional hardware or complicated circuits, enhancing user experience, reducing maintenance costs, and reducing the requirements for firmware updates (e.g., reducing the circuit complexity), providing fast and convenient peripheral maintenance to all users.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for updating firmware of a first peripheral device of a first computer system in a computer network, the first computer system comprising a first host, a first system on chip (SoC), and a first basic input/output system (BIOS), the first host being coupled to the first SoC, the first SoC being coupled to the first BIOS, the first BIOS being coupled to the first peripheral device, the method comprising:
a first operating system (OS) running on the first host controlling the first SoC to initiate a firmware update of the first peripheral device;
in response to the firmware update of the first peripheral device, the first SoC enabling the first BIOS to enter a first unified extensible firmware interface (UEFI);
the first UEFI executing an update script to update a peripheral firmware to the first peripheral device; and
performing a reboot to complete the firmware update of the first peripheral device.

2. The method of claim 1, wherein the update script is stored in the first host.

3. The method of claim 1, wherein:
the peripheral firmware is stored in the first host; and
the first UEFI executing the update script to update the peripheral firmware to the first peripheral device comprises: the first UEFI obtaining the peripheral firmware from the first host.

4. The method of claim 1, wherein the first SoC enabling the first BIOS to enter the first UEFI comprises:
after the first computer system is rebooted, the first SoC enabling the first BIOS to enter the first UEFI.

5. The method of claim 1, wherein the first operating system running on the first host computer controlling the first SoC to initiate the firmware update of the first peripheral device comprises:
the first operating system sending a first instruction to the first SoC to enable the first BIOS to enter the first UEFI.

6. The method of claim 5, wherein the first operating system running on the first host computer controlling the first SoC to initiate the firmware update of the first peripheral device further comprises:
the first operating system sending a second instruction to the first SoC to designate the first peripheral device to perform the firmware update.

7. The method of claim 5, wherein the first operating system running on the first host computer controlling the first SoC to initiate the firmware update of the first peripheral device further comprises:
the first operating system sending a second instruction to the first SoC to designate the first peripheral device and another peripheral device of the first computer system to perform the firmware update.

8. The method of claim 1, wherein the first peripheral device is a peripheral component interconnect express (PCI-E) device.

9. The method of claim 1, wherein the first SoC is a baseboard management controller (BMC).

10. The method of claim 1, wherein the computer network further comprises a central control computer and a second computer system, and the second computer system comprising a second host, a second SoC, a second BIOS, the second host being coupled to the second SoC, the second SoC being coupled to the second BIOS, and the second BIOS being coupled to a second peripheral device of the second computer system, the central control computer being coupled to the first computer system and the second computer system, the method further comprising:
the central control computer sending a firmware update instruction to trigger the first computer system to perform the firmware update of the first peripheral device and trigger the second computer system to perform a firmware update of the second peripheral device;
a second operating system running on the second host controlling the second SoC to initiate the firmware update of the second peripheral device;
in response to the firmware update of the second peripheral device, the second SoC enabling the second BIOS to enter a second UEFI;
the second UEFI executing the update script to update the peripheral firmware to the second peripheral device; and
performing a reboot to complete the firmware update of the second peripheral device.

11. A computer network comprising:
a first computer system comprising:
a first host comprising a first operating system (OS);
a first system on chip (SoC) coupled to the first host; and
a first basic input/output system (BIOS) coupled to the first host, the first SoC, and a first peripheral device;
wherein the first operating system is configured to run on the first host to control the first SoC to initiate a firmware update of the first peripheral device;
in response to the firmware update of the first peripheral device, the first SoC is configured to enable the first BIOS to enter a first unified extensible firmware interface (UEFI);
the first UFI is configured to execute an update script to update a peripheral firmware to the first peripheral device; and
the first computer system is configured to perform a reboot to complete the firmware update of the first peripheral device.

12. The computer network of claim 11, wherein the update script is stored in the first host.

13. The computer network of claim 11, wherein:
the peripheral firmware is stored in the first host; and
the first UEFI is configured to obtain the peripheral firmware from the first host.

14. The computer network of claim 11, wherein after the first computer system is rebooted, the first SoC is configured to enable the first BIOS to enter the first UEFI.

15. The computer network of claim 11, wherein the first operating system is configured to send a first instruction to the first SoC to enable the first BIOS to enter the first UEFI.

16. The computer network of claim 15, wherein the first operating system is configured to send a second instruction to the first SoC to designate the first peripheral device to perform the firmware update.

17. The computer network of claim 15, wherein the first operating system configured to send a second instruction to the first SoC to designate the first peripheral device and another peripheral device of the first computer system to perform the firmware update.

18. The computer network of claim 11, wherein the first peripheral device is a peripheral component interconnect express (PCI-E) device.

19. The computer network of claim 11, wherein the first SoC is a baseboard management controller (BMC).

20. The computer network of claim 11, further comprising:
a central control computer coupled to the first computer system; and
a second computer system coupled to the central control computer, and comprising:
a second host comprising a second operating system;
a second SoC coupled to the second host; and
a second BIOS coupled to the second host, the second SoC, and a second peripheral device;
wherein the central control computer is configured to send a firmware update instruction to trigger the first computer system to perform the firmware update of the first peripheral device and trigger the second computer system to perform a firmware update of the second peripheral device;
the second operating system is configured to run on the second host to control the second SoC to initiate the firmware update of the second peripheral device;
in response to the firmware update of the second peripheral device, the second SoC is configured to enable the second BIOS to enter a second UEFI;
the second UEFI is configured to execute the update script to update the peripheral firmware to the second peripheral device; and
the second computer system is configured to perform a reboot to complete the firmware update of the second peripheral device.
